(19) United States
(12) Patent Application Publication
(10) Pub. No.: US 2020/0408324 A1
(43) Pub. Date: Dec. 31, 2020

(54) Valve

(71) Applicant: Vitesco Technologies GmbH, Hannover (DE)

(72) Inventor: Rosario BONANNO, Schwalbach a. Ts. (DE)

(21) Appl. No.: 16/956,039

(22) PCT Filed: Dec. 19, 2018
(86) PCT No.: PCT/EP2018/085826

§ 371 Date: Jun. 19, 2020

(30) Foreign Application Priority Data
Dec. 21, 2018 (DE) 10 2017 223 581.0

(51) Int. Cl. F16K 31/06; F16K 27/02; H01F 7/08; H01F 7/16

(52) U.S. Cl. CPC F16K 31/0675; F16K 27/029; H01F 2007/086; H01F 7/081; H01F 7/1607; F16K 31/0655

(57) ABSTRACT

A valve includes: a housing; a solenoid arranged in the housing, the solenoid comprising a coil, an armature, an upper stator and a lower stator, the armature and the upper and lower stators being configured such that, when a magnetic force acts between the upper and lower stators, the armature moves axially; a pin connected to the armature; a cup-shaped piston connected to the pin; a spring, configured to provide a force that moves the piston away from the solenoid in a case in which no magnetic force acts between the upper and lower stators; and a protective sleeve arranged in the solenoid, the protective sleeve being made of a corrosion-resistant material.

### CROSS REFERENCE TO RELATED APPLICATIONS

This is a U.S. national stage of International application No. PCT/EP2018/085826, filed on Dec. 19, 2018, which claims priority to German Application No. 10 2017 223 581.0, filed Dec. 21, 2017, the content of each of which is incorporated herein by reference.

### BACKGROUND OF THE INVENTION

### 1. Field of the Invention

The invention relates to a valve comprising a housing and a solenoid arranged in the housing.

### 2. Description of the Prior Art

Such valves are used, inter alia, as a diverter valve on the turbocharger in motor vehicles to open up a bypass to the suction side in overrun operation, and are thus known. To prevent excessive deceleration of the turbocharger, and also to ensure a fast start-up, rapid opening and closing of the valve are essential prerequisites. In particular during the closing process, immediate closure as a result of the abutment of the piston against a valve seat is of importance. The valve seat is formed by the housing of the turbocharger, on which the valve is flange-mounted. Here, the axially displaceable piston is sealed against the housing. The piston has openings, enabling a medium present in the bypass line to penetrate into the interior of the valve. This pressure equalization is used for the opening and closing of the valve. A disadvantage is that the medium contains aggressive components that attack the magnetic materials of the valve, causing them to corrode. This results in power losses and functional impairments.

### SUMMARY OF THE INVENTION

It is therefore an underlying object of the invention to provide a valve that suffers only slight impairments, if any, due to corrosion over the entire service life. The valve should furthermore be of simple design.

This object may be achieved, according to an aspect of the invention, wherein the solenoid comprises a coil, an armature, an upper stator and a lower stator, and the stators are designed in such a way that, when a magnetic force acts between the stators, the armature moves axially, further comprising a pin, which is firmly connected to the armature, a cup-shaped piston, which is connected to the pin, and a spring, which moves the piston away from the solenoid in the event of a loss of the magnetic force.

A protective sleeve composed of a corrosion-resistant material is arranged in the solenoid. The arrangement of a protective sleeve of this kind requires little effort and, at the same time, provides reliable protection from the aggressive components in the medium flowing in the bypass line. A protective sleeve can be produced easily, and the installation of the protective sleeve also requires only a few additional working steps.

In order to protect the magnetic materials from corrosion, it is advantageous if the protective sleeve is made of a resistant plastic. Owing to the forces acting in the solenoid and to movements, the plastic must have a certain wall thickness. According to another embodiment, it has proven advantageous to produce the protective sleeve from high-grade steel. In addition to the excellent protective properties, high-grade steel has sufficient stability to enable the protective sleeve to be formed with thin walls. Thus, it has proven advantageous to form the protective sleeve with a wall thickness of 0.1 mm to 0.5 mm, preferably 0.2 mm to 0.4 mm and, in particular, 0.25 mm. The advantage is that the solenoid requires only slight modification for the use of such a protective sleeve. Complex redesigns of valves are not required, and even existing valves can be adapted with little effort.

One low-cost embodiment is if the protective sleeve is composed of a chromium-nickel steel.

According to another advantageous embodiment, reliable protection of the components to be protected is achieved by virtue of the fact that the protective sleeve is arranged between the armature and the upper and lower stator. Since the protective sleeve directly surrounds the corresponding components, a maximum protective effect is ensured.

In another embodiment, the protective sleeve is pressed into an aperture in the upper stator, while the protective sleeve is separated from the lower stator by a radial air gap. This air gap is a few tenths of a millimeter. The press fitting ensures that the protective sleeve remains without any change in its installed position, even in the case of high forces acting externally on the valve.

If the upper stator has a central aperture, into which the armature enters when the solenoid is energized, a particularly advantageous embodiment consists in pressing the protective sleeve into this aperture in the upper stator. On the one hand, this enables the protective sleeve to be configured as a cylindrical part and thus in a very low-cost way. On the other hand, the protective sleeve simultaneously performs the guidance of the armature during the opening and closing of the valve. Owing to thermal effects, the components of the solenoid may perform movements relative to one another. In order to avoid introducing stresses into the solenoid, it has proven advantageous to press the protective sleeve into the aperture in the upper stator in such a way that the upper edge of the protective sleeve is arranged without making stop contact in the upper stator.

In another advantageous embodiment, the protective sleeve has a flange, which rests against the lower stator. This flange is used, on the one hand, to prevent aggressive components from the bypass line from being able to penetrate into the at-risk regions. On the other hand, the flange serves as a stop during press fitting, thus enabling the correct installation of the protective sleeve to be implemented in a particularly simple manner.

In another embodiment, an additional protection of the magnetic materials and permanent fixing of the protective sleeve are achieved by virtue of the fact that the protective sleeve is overmolded by the housing, at least in a partial region of the flange.

### BRIEF DESCRIPTION OF THE DRAWINGS

The invention will be described in more detail on the basis of an exemplary embodiment. In the figures:

FIG. 1 shows a sectional illustration of a valve according to the prior art; and

FIG. 2 shows an enlarged sectional illustration of the valve according to the invention in the region of the solenoid.

### DETAILED DESCRIPTION OF THE PRESENTLY PREFERRED EMBODIMENTS

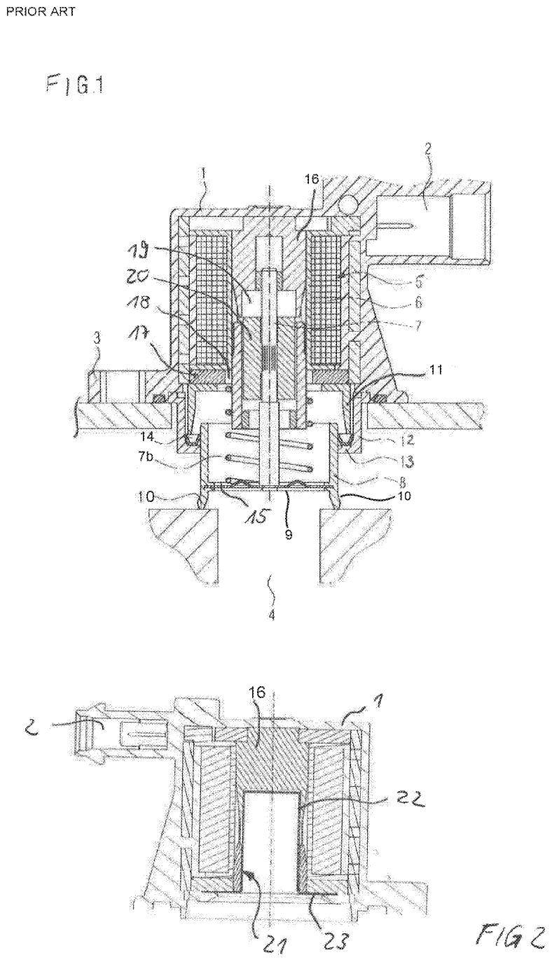

FIG. 1 shows the valve, which comprises a housing 1. The housing 1 furthermore has an integrally formed flange 3, via which the housing 1 is flanged-mounted on a turbocharger (not illustrated) in the region of a bypass line. The electrical contacting of a solenoid 5, which is arranged in the housing 1, is accomplished via a socket 2. The solenoid 5 has a coil 6, which acts on a metal pin 7. The metal pin 7 is connected to a cup-shaped piston 8, which, at the periphery of its base 9, has a sealing surface 10 that interacts with a valve seat (not illustrated). Here, a spring 7b pushes the piston 8 in the direction of the valve seat. The housing 1 furthermore has a cylindrical section 11 which extends in the direction of the piston 8. A cylinder bushing 12 connected to the housing surrounds the cylindrical section 11. The cylinder bushing 12 has a radially inwardly directed collar 13, on which a seal 14 rests. Here, the seal 14 seals the piston against the housing 1. Apertures 15 in the piston 8 allow pressure equalization in the valve. As a result, however, aggressive components in the exhaust gas also get into the interior of the valve. The solenoid 5 comprises an upper stator 16 and a lower stator 17. The two stators 16, 17 each have a central aperture 19, 18, respectively. In the deenergized state of the solenoid 5, an armature 20 firmly connected to the metal pin is situated in the aperture 18 in the lower stator 17. When the solenoid 5 is energized, the armature 20 and, with it, the metal pin 7 is pulled upward with the piston 8. During this process, the armature 20 enters the aperture 19 in the upper stator 16.

The valve according to the invention in FIG. 2 is illustrated without the armature, the pin and the piston. It has a protective sleeve 21 composed of chromium-nickel steel with a wall thickness of 0.3 mm. The protective sleeve has a cylindrical section 22, which merges at the lower end into a flange 23. The protective sleeve is pressed by its cylindrical section 22 into the aperture 19 in the upper stator 16. The protective sleeve 21 has been pressed on to such an extent that, in the installed state, the flange 23 rests against the lower end of the coil 6. Here, the rubber coating on the protective sleeve 21 ensures improved sealing. The radially outer edge of the flange 23 is overmolded by the housing 1, as a result of which good sealing is achieved.

Although exemplary embodiments have been discussed in the above description, it should be noted that numerous modifications are possible. Furthermore, it should be noted that the exemplary embodiments are merely examples which are not intended to limit the scope of protection, the applications and the structure in any way. Rather, a person skilled in the art will take from the above description a guideline for implementation of at least one exemplary embodiment, wherein various modifications may be made, in particular with regard to the function and arrangement of the described components, without departing from the scope of protection as can be gathered from the claims and equivalent feature combinations.

1-8. (canceled)

9. A valve comprising:
a housing;
a solenoid arranged in the housing, the solenoid comprising a coil, an armature, an upper stator and a lower stator, the armature and the upper and lower stators being configured such that, when a magnetic force acts between the upper and lower stators, the armature moves axially;
a pin connected to the armature;
a cup-shaped piston connected to the pin;
a spring, configured to provide a force that moves the piston away from the solenoid in a case in which no magnetic force acts between the upper and lower stators; and
a protective sleeve (21) arranged in the solenoid (5), the protective sleeve (21) being made of a corrosion-resistant material.

10. The valve as claimed in claim 9, wherein the corrosion-resistant material is high-grade steel.

11. The valve as claimed in claim 10, wherein the high-grade steel is a chromium-nickel steel.

12. The valve as claimed in claim 9, wherein the protective sleeve (21) has a wall thickness of 0.1 mm to 0.5 mm, or 0.2 mm to 0.4 mm, or 0.25 mm.

13. The valve as claimed in claim 9, wherein the protective sleeve (21) is arranged in the solenoid (5) between the armature (20) and the upper and lower stator (16, 17).

14. The valve as claimed in claim 13, wherein the protective sleeve (21) arranged in an aperture (19) in the upper stator (16), so as to form a radial air gap between the lower stator (17) and the protective sleeve (21).

15. The valve as claimed in claim 13, wherein the protective sleeve (21) has a flange (23), configured to rest against the lower stator (17).

16. The valve as claimed in claim 15, wherein the protective sleeve (21) is encased by the housing (1), at least in a partial region of the flange (23).
